(19) United States
(12) Patent Application Publication
(10) Pub. No.: US 2003/0063186 A1
(43) Pub. Date: Apr. 3, 2003

(54) 2D/3D convertible display

(75) Inventor: Takao Tomono, Seoul (JP)

Correspondence Address: SUGHRUE MION, PLLC, 2100 Pennsylvania Avenue, NW, Washington, DC, 20037-3213, US

(73) Assignee: Samsung Electronics Co. Ltd.

(21) Appl. No.: 10/238,886

(22) Filed: Sep. 11, 2002

(30) Foreign Application Priority Data
Sep. 11, 2001 (KR) 2001-55917

(51) Int. Cl. H04N 13/04; H04N 15/00

(52) U.S. Cl. 348/51

(57) ABSTRACT

A two-dimensional (2D)/three-dimensional (3D) convertible display using a micro lens array, and more particularly, a 2D/3D convertible display, which can be easily converted between 2D and 3D display mode using an electro-optic material of which the refractive index varies according to applied power is provided. In the 2D/3D convertible display in a stereoscopic video display comprising an imaging display and a lens unit, which is formed on the front surface of the imaging display and converts video that is emitted from the imaging display into 3D video, the lens unit includes an electro-optic material of which the refractive index is selectively adjusted according to the position of the lens unit due to applied power and is a liquid crystal layer that serves as a lens according to the sequential variation in the refractive index. A system capable of easily selecting 2D/3D can be used in many fields, which are in need of greatly improved video information, such as medical science, engineering, simulation, and a stereoscopic video TV, which will emerge in the near future.

### BACKGROUND OF THE INVENTION

1. Field of the Invention

The present invention relates to a two-dimensional (2D)/three-dimensional (3D) convertible display using a micro lens array, and more particularly, to a 2D/3D convertible display, which can be easily converted between a 2D display and a 3D display and vice versa, using an electro-optic material of which the refractive index varies according to applied power. The present application is based on Korean Patent Application No. 2001-55917, filed Sep. 11, 2001, which is incorporated herein by reference.

2. Description of the Related Art

A stereoscopic video display, which displays three-dimensional (3D) video broadly including stereoscopic images and 3D images, is classified on the basis of stereoscopic display method, viewpoint, observation conditions and the condition of whether or not an observer wears supplementary glasses. Binocular parallax is used so that an observer recognizes video that is provided by a display stereoscopically. That is, if video that is observed from various angles is received by both eyes, the observer's brain perceives the video in three dimensions. A display method includes stereoscopic display and volumetric display on the basis of recognition of stereoscopic views from a stereoscopic video display. In the stereoscopic display, two portions of a 2D image having binocular parallax are divided into images that are taken from the right and left eye, respectively, to allow stereoscopic recognition. Since right and left images that are taken from the two eyes are displayed, there is a disadvantage of stereoscopic views in which they are recognized only from a single viewpoint. In the volumetric display, stereoscopic images in which an object is taken in various directions is displayed. Thus, there is an advantage in obtaining 3D images even in a case where an observing position varies, that is, in a case where the observer observes the object from various directions.

A method for displaying 3D images, which is a technique of displaying 3D images and displays binocular parallax images that are taken in various directions, includes a parallax panoramagram method, a lenticular method, an integral photography or volumetric-graph (IP) method, and a slit scan method.

Among the methods, the IP method does not require additional glasses for observation, and in the IP method, stereoscopic video is automatically obtained in a desired position, and thus the IP method is very useful to create 3D video. A display using the IP method includes a micro lens array or pinhole array and is used in many applications such as medical science, engineering, and simulation.

FIG. 1 illustrates a conventional 3D video system and method for implementing the same. An optical diffusion layer 112 is formed between first and second micro lens arrays 111 and 113, e.g., fly eye lenses, and a third micro lens array 114 having the same structure is formed on the front surface of a photosensitive layer 115 of a TV pickup tube 116, to be opposite to the second micro lens array 113.

A display 119 includes a fluorescent screen 120, and a fourth micro lens array 121 is formed on the front surface where a viewer senses video. Here, a 3D signal including video that is taken by a camera through a micro lens system, is transmitted to a receiving unit 118 through a transmitting unit 117. This transmission system receives and transmits signals in a conventional manner. The signal from the receiving unit 118 forms an image on a fluorescent screen 120 of a display 119 and is recognized through the fourth micro lens array 121, and the image that is formed on the fluorescent screen 120 is the same as an image that is formed on a photosensitive layer 115 of a TV picture tube 116 through the first, second, and third micro lens arrays 111, 113, and 114. The fourth micro lens array 121 that is formed on the display 119 has the same structure as those of lens systems, which are formed on the TV pickup tube 116, and the relation of a micro lens system to the display 119 is the same as that of a micro lens system to the TV pickup tube 116. Thus, a viewer views images through the micro lens system from the front surface of the fourth micro lens array 121 of the display 119, thereby recognizing virtual stereoscopic video of an actual object.

A system for simulation or medical analysis, in which an actual display is used, also requires 2D video. However, in the conventional 3D display, 2D and 3D video cannot be selectively implemented.

### SUMMARY OF THE INVENTION

To solve the above problem, it is an object of the present invention to provide a two-dimensional (2D)/three-dimensional (3D) convertible display, which is capable of implementing 2D and 3D images in a single display without adding an additional device.

Accordingly, to achieve the object, there is provided a two-dimensional (2D)/three-dimensional (3D) convertible display in a stereoscopic video display comprising an imaging display and a lens unit, which is formed on the front surface of the imaging display and converts video that is emitted from the imaging display into 3D video, wherein the lens unit includes an electro-optic material of which the refractive index is selectively adjusted according to the position of the lens unit due to applied power and is a liquid crystal layer that serves as a lens according to the sequential variation in the refractive index.

It is preferable that the lens unit includes a first transparent substrate, lower electrodes formed on the first transparent substrate, a liquid crystal layer formed on the lower electrodes, including an electro-optic material, upper electrodes formed on the liquid crystal layer, and a second transparent substrate formed on the upper electrodes.

It is also preferable that the display further includes a power supply unit for applying power to the lower and upper electrodes, and the imaging display includes a cathode ray tube (CRT), a liquid crystal display (LCD), a plasma display, or an electric luminescence (EL) display.

It is also preferable that the first transparent substrate and the second transparent substrate are orientation-processed in the same direction, and power is selectively applied to the liquid crystal layer through the lower and upper electrodes in a 3D mode, and the refractive index of the liquid crystal layer is sequentially varied so that the liquid crystal layer has a self focusing lens shape.

The electro-optic material of the liquid crystal layer is preferably a nematic material.

### BRIEF DESCRIPTION OF THE DRAWINGS

The above object and advantages of the present invention will become more apparent by describing in detail a preferred embodiment thereof with reference to the attached drawings in which:

FIG. 1 illustrates the structure of a conventional 3D video display;

FIG. 2 is a cross-sectional view of a 2D/3D convertible display according to the present invention;

FIG. 3 is a cross-sectional view illustrating a principle of implementing 3D video in the 2D/3D convertible display according to the present invention;

FIG. 4A is an exploded perspective view illustrating a case where a lens unit serves as a lenticular lens, in the 2D/3D convertible display according to the present invention; and

FIG. 4B is an exploded perspective view illustrating a case where the lens unit serves as a fly eye lens, in the 2D/3D convertible display according to the present invention.

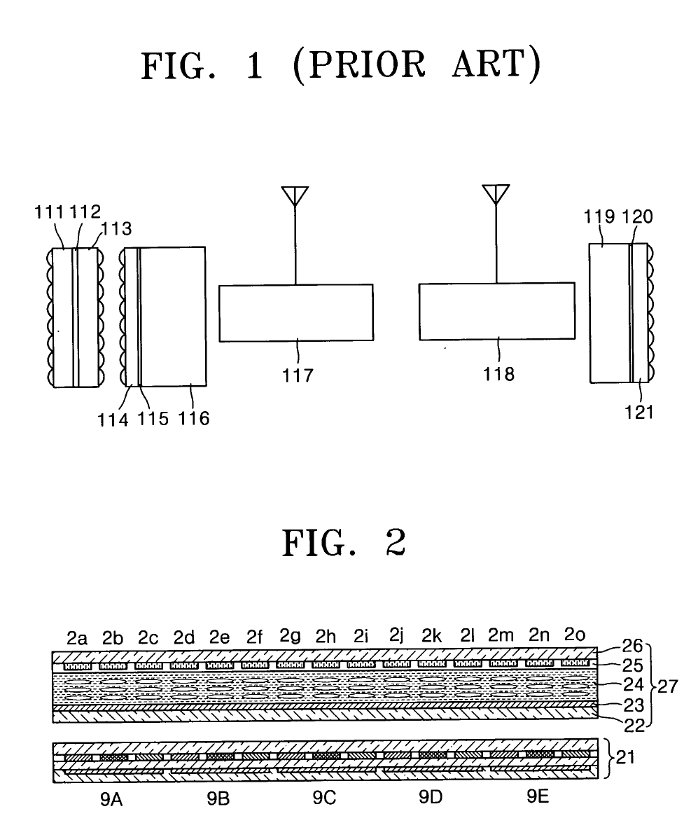

### DETAILED DESCRIPTION OF THE INVENTION

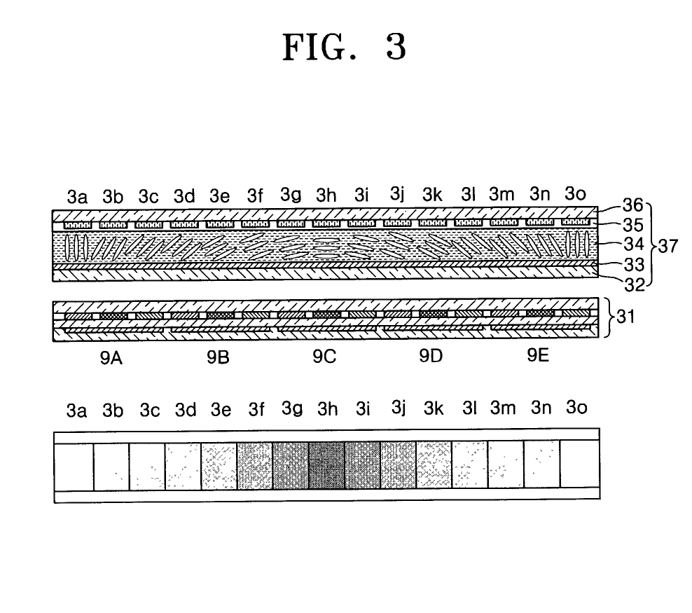

FIG. 2 is a cross-sectional view of a 2D/3D convertible display according to the present invention. The 2D/3D convertible display according to the present invention includes an imaging panel display 21, a lens unit 27, and a power supply unit (not shown) for selectively supplying power to the lens unit 27.

A video display that is generally used, having high resolution and small pitch size, such as a television, a monitor, a liquid crystal display (LCD), a plasma display, and an electric luminescence (EL) display, is used as the imaging panel display 21. Thus, in general, the imaging panel display 21 receives a video signal, outputs the received video signal without change, and a general video implementation medium may be used as the imaging panel display 21.

The lens unit 27 is positioned on the front surface of the imaging panel display 21 and represents video, which is emitted from the imaging panel display 21, stereoscopically. Here, the lens unit 27 includes a first transparent substrate 22, lower electrodes 23 that are formed on the first transparent substrate 22, a liquid crystal layer 24 that is formed on the lower electrodes 23, upper electrodes 25 that are formed on the liquid crystal layer 24, and a second transparent substrate 26 that is formed on the upper electrodes 25. An insulating layer may be included between the first and second transparent substrates 22 and 26 and the lower and upper electrodes 23 and 25.

The lower electrodes 23 and the upper electrodes 25 may be formed of a transparent material, such as InSn Oxide (ITO), like in the first and second transparent substrates 22 and 26.

The lower and upper electrodes 23 and 25 intersect with one another and are formed in a line shape, and the width of the lower and upper electrodes 23 and 25 may correspond to pixels of the imaging panel display 21 so that a portion of the liquid crystal layer 24 to which power is applied is adjusted in units of the pixels of the imaging panel display 21.

The liquid crystal layer 24 is made of an electro-optic material of which the refractive index varies according to the external application of power, such as a nematic material as disclosed in U.S. Pat. No. 4,037,929. The liquid crystal layer 24 is treated so that the electro-optic material of the liquid crystal layer is oriented in a planar direction. In this case, as shown in FIG. 2, the electro-optic material of the liquid crystal layer 24 has the same orientation in a case where power is not applied from outside. If power is applied to the liquid crystal layer 24, and if the liquid crystal layer 24 is made of a nematic material, the refractive index of the nematic material varies from 1.52 to 1.75 according to the external application of power. The quantity of transmitted light varies according to the variation in the refractive index.

A method for implementing 2D and 3D video of the 2D/3D convertible display according to the present invention will be described below.

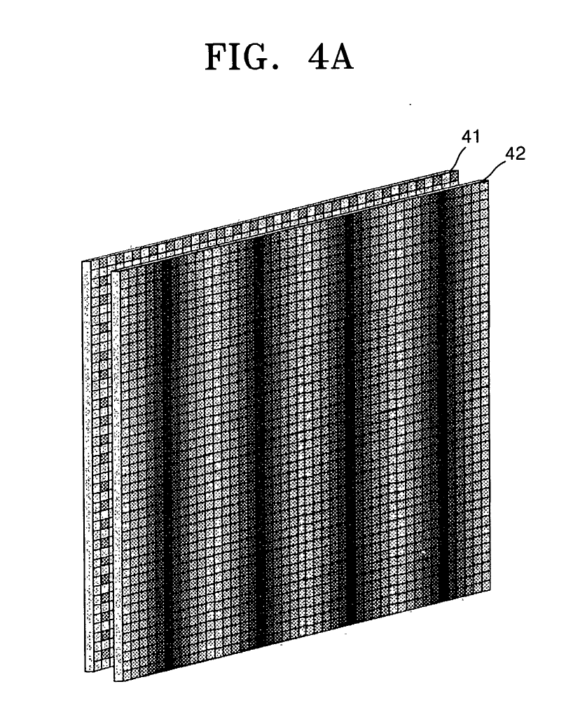

First, a case where 3D video is implemented will be described with reference to FIG. 3. In a case where power is applied from outside by the power supply unit, power is applied to a liquid crystal layer 34 through lower and upper electrodes 33 and 35. In such a case, power that is applied to the lower electrodes varies. This is same as in the upper electrodes 35. In a case where different power is applied to the lower and upper electrodes 33 and 35, power that is applied to each portion of the liquid crystal layer 34 varies. Thus, the orientation of the electro-optic material of the liquid crystal layer 34 varies in each region of the liquid crystal layer 34.

A case where the orientation of the liquid crystal layer 34 varies when different power is applied to the lower and upper electrodes 33 and 35 is shown in FIG. 3. Likewise, power is not applied to a portion 3h of FIG. 3, and in this case, the quantity of transmitted light that is emitted from an imaging panel display 31 is very small. Power is applied to portions 3a and 3o so that the orientation of the electro-optic material of the liquid crystal layer 34 varies relatively highly in a vertical direction. In this case, the highest quantity of light emitted from the imaging panel display 31 is transmitted. That is, it is known that the quantity of transmitted light varies in each portion of the liquid crystal layer 34 according to the application of power. It may be assumed from this principle that portions from 3a to 3o of the liquid crystal layer 34 are one lens, and the lens is referred to as a self focusing lens or graded index lens. Thus, received video may be implemented as 3D video by the liquid crystal layer 34 serving as a lens with respect to the image from the imaging panel display 31.

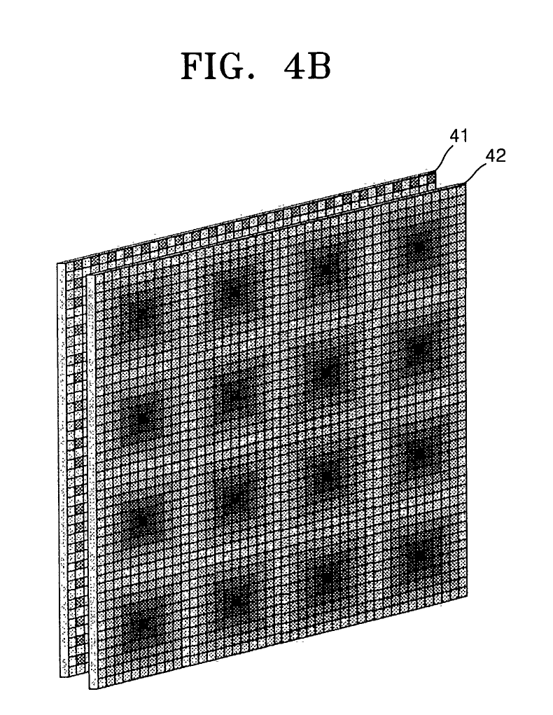

Lenses having various shapes may be implemented on the basis of this principle. That is, as shown in FIG. 4A, a fly eye lens or lenticular lens may be implemented. As described above, different power is applied to the liquid crystal layer 34 through the lower electrodes 33 and the upper electrodes 35 of a lens unit 37, and thereby there is a difference in the quantity of transmitted light in each region of the liquid crystal layer 34, and the liquid crystal layer 34 has a self focusing lens shape to act as a lens. Thus, the lens shape is not limited to a specific shape but the size and shape of the lens may be adjusted.

2D video may be implemented by passing video that is emitted from the imaging panel displays 21 and 31 without filtering in the lens unit 37. That is, in a case where same power is applied to the lower electrodes 23 and 33 and the upper electrodes 25 and 35 of the lens units 27 and 37, the liquid crystal layers 24 and 34 just serve as a glass plate, and there is no difference in the quantity of transmitted light with respect to position. Thus, the 2D video may be easily implemented.

Thus, the refractive indices with first and second transparent substrates 32 and 36 are adjusted to be the same according to the external application of power, thereby forming the liquid crystal layer 34. In a case where the power that is applied to the liquid crystal layer 34 varies according to each of the electrodes, power that is applied to the liquid crystal layer 34 varies by location, so that the quantity of transmitted light also varies by location. Here, when the difference in the power that is applied to each region of the liquid crystal layer 34 is adjusted, the liquid crystal layer 34 may serve as a lens such as a self focusing lens. The power that is applied to the lens unit 37 in the same display is adjusted so that the 2D/3D convertible display is implemented.

Lenses having various shapes may be implemented on the basis of this principle, as shown in FIGS. 4A and 4B. FIG. 4A illustrates a lens unit 42 for serving as a lenticular lens according to an embodiment of the present invention, and in FIG. 4A, four units of the lenticular lens having varying shades are provided.

FIG. 4B illustrates the lens unit 42 for serving as a fly eye lens according to another embodiment of the present invention, and in FIG. 4B, sixteen units of the fly eye lens having varying shades are provided. In the embodiments shown in FIGS. 4A and 4B, in a case where power that is applied to lower and upper electrodes is selectively adjusted, lenses having various shapes can be easily implemented.

According to the present invention, a system capable of easily selecting 2D/3D can be used in many fields, which are in need of greatly improved video information, such as medical science, engineering, simulation, and stereoscopic video TV, which will emerge in the near future.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A two-dimensional (2D)/three-dimensional (3D) convertible display in a stereoscopic video display, comprising:
an imaging display; and
a lens unit, the lens unit being disposed on a front surface of the imaging display and converts video that is emitted from the imaging display into 3D video, wherein the lens unit includes an electro-optic material of which the refractive index is selectively adjusted according to the position of the lens unit due to applied power and is a liquid crystal layer that serves as a lens according to sequential variation in the refractive index.

2. The display of claim 1, wherein the lens unit comprises:
a first transparent substrate;
lower electrodes disposed on the first transparent substrate;
a liquid crystal layer disposed on the lower electrodes, including an electro-optic material;
upper electrodes disposed on the liquid crystal layer; and
a second transparent substrate disposed on the upper electrodes.

3. The display of claim 2, further comprising a power supply unit for applying power to the lower and upper electrodes.

4. The display of claim 2, wherein the imaging display includes a cathode ray tube (CRT), a liquid crystal display (LCD), a plasma display, or an electric luminescence (EL) display.

5. The display of claim 2, wherein the first transparent substrate and the second transparent substrate are orientation-processed in same direction.

6. The display of claim 2, wherein power is selectively applied to the liquid crystal layer through the lower and upper electrodes in a 3D mode, and the refractive index of the liquid crystal layer is sequentially varied so that the liquid crystal layer has a self focusing lens shape.

7. The display of claim 2, wherein the electro-optic material of the liquid crystal layer is a nematic material.

8. A two-dimensional (2D)/three-dimensional (3D) convertible display in a stereoscopic video display, comprising:
an imaging display; and
a lens unit, the lens unit being disposed on a front surface of the imaging display, wherein the lens unit includes an electro-optic material of which the refractive index of selected portions is selectively adjusted by applying power so as to serve as a lens according to sequential variation in the refractive index when in a 3D mode.

9. The two-dimensional (2D)/three-dimensional (3D) convertible display of claim 8, wherein the lens unit is transparent when power is not applied to the lens unit in a 2D mode.

10. The two-dimensional (2D)/three-dimensional (3D) convertible display of claim 8, wherein the lens unit is adapted to act as a lenticular lens upon application of appropriate power.

11. The two-dimensional (2D)/three-dimensional (3D) convertible display of claim 8, wherein the lens unit is adapted to act as a fly eye lens upon application of appropriate power.
